(19) United States
(12) Patent Application Publication
(10) Pub. No.: US 2011/0006870 A1
(43) Pub. Date: Jan. 13, 2011

(54) Coil Component And Method For Manufacturing Coil Component

(75) Inventor: Shinichi Sakamoto, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SUMIDA CORPORATION, Tokyo (JP)

(21) Appl. No.: 12/673,632

(22) PCT Filed: Jun. 6, 2008
(86) PCT No.: PCT/JP2008/060429

§ 371 Date: Feb. 16, 2010

(30) Foreign Application Priority Data
Aug. 31, 2007 (JP) 2007-226987

(51) Int. Cl. H01F 17/04; B29C 45/14

(52) U.S. Cl. 336/221; 264/272.19

(57) ABSTRACT

In an inductor including a coil, a drum type core constituted by a soft magnetic metal material and a resin material, and a filling member constituted by a soft magnetic metal material and a resin material in which a magnetic flux excited by aforesaid coil goes through aforesaid drum type core and aforesaid filling member serially, the present invention constitutes an inductor, wherein aforesaid drum type core is constituted by injection molding so as to include a receiving portion, aforesaid coil is arranged in aforesaid receiving portion, and aforesaid filling member is filled therein.

### TECHNICAL FIELD

The present invention relates to a coil component and a manufacturing method of the coil component, and more particularly, relates to a small-sized coil component used in an electronic apparatus and a manufacturing method of the coil component.

### BACKGROUND ART

In recent years, along with miniaturization of an electronic apparatus, a request for miniaturization with respect to a coil component of an inductor or the like has been issued strongly. When forming an inductor in a small size, for example, thickness of a flange included in a core becomes thin and there will occur such a problem that strength of the inductor lowers.

In order to solve this problem, there is known a technology in which a core forming a post shape is molded by using a compound member obtained by mixing a function material powder and a resin, whose strength is heighten than that of a sintered core composed of ferrite core or the like (for example, see Patent Document 1).

Also, a technology is known as a technology for reducing leakage magnetic flux in which there is used a sintered ferrite core or a pressed powder magnetic core made of metal magnetic powders, and a compound member obtained by mixing metal magnetic material powders and resin is filled in a coil portion including a coil arranged for the core (for example, see Patent Document 2 and Patent Document 3).
Patent Document 1: Japanese unexamined patent publication No. 2003-297642
Patent Document 2: Japanese unexamined patent publication No. 2001-185421
Patent Document 3: Japanese unexamined patent publication No. 2004-281778

### DISCLOSURE OF THE INVENTION

However, according to the technology disclosed in the above-mentioned Patent Document 1, extrusion molding is used and therefore, only a post shaped core can be molded and it is not possible to mold a core of a complex shape. In addition, there are included a process for winding a wire member around a extrusion core member, a process for cutting the extrusion core member, and a process for covering an external cladding at a coil periphery portion and the like, and there arises a fear of a large scaled production facility and also of an increase in the facility cost.

Also, in the technology disclosed in the Patent Document 2 and the Patent Document 3, there is used sintered ferrite material or a pressed powder magnetic material of metal magnetic powders for a core, so that there is a trend that the thickness of the core becomes thin in case of miniaturizing the electric component and it is difficult to get enough strength thereof.

The present invention takes the matter mentioned above into consideration and it is possible to get enough strength with respect to a shock of core falling or the like compared with a sintered core even if the electric component becomes small sized. Also, by injection-molding a core having a receiving portion, it is possible to fill aforesaid compound magnetic resin easily in the receiving portion of the core, and there is offered a coil component in which leakage magnetic flux is little and the electric characteristic is excellent and there is offered a manufacturing method of the coil component thereof.

The present invention was invented in order to achieve the object such as mentioned above and this object can be achieved by the following inventions (1) to (3).

(1) In a coil component characterized by including:

a coil;

a compound magnetic core constituted by a soft magnetic metal material and a resin material; and

a compound magnetic resin constituted by a soft magnetic metal material and a resin material, in which

it is constituted such that magnetic flux excited by aforesaid coil serially goes through aforesaid compound magnetic core and aforesaid compound magnetic resin, wherein

aforesaid compound magnetic core is constituted by injection molding so as to include a receiving portion, and

aforesaid coil is arranged in aforesaid receiving portion and aforesaid compound magnetic resin is filled therein.

(2) The coil component described in the above (1) characterized in that

aforesaid compound magnetic core is constituted by a soft magnetic metal material and a thermo-setting resin material or a thermoplastic resin material.

(3) A manufacturing method characterized by including:

a process of molding a core by injection-molding a compound material constituted by a soft magnetic metal material and resin material;

a process of housing a coil in aforesaid molded core; and

a process of coating aforesaid coil with a compound material constituted by a soft magnetic metal material and a resin material after housing aforesaid coil in aforesaid core.

According to a coil component based on the present invention, it is possible to improve impact resistance capability compared with that of a sintered ferrite core or the like by injecting a compound material which is constituted by a magnetic material and a resin material to mold the core, and it is possible to prevent core damage of a core crack or the like. In addition, by using aforesaid compound material and by filling the compound material composed of the magnetic material and the resin material also for the coil portion, it is possible to improve not only the impact resistance capability but also withstand voltage property or anticorrosion property.

According to a manufacturing method of the coil component based on the present invention, it is possible to manufacture a complexly shaped core easily by using injection-molding and in addition, differently from a manufacturing method of a ferrite sintered core or the like, a process referred to as cutting is not necessary, so that it is possible to attempt improvement of the yield and improvement of the core productivity.

### BRIEF DESCRIPTION OF DRAWINGS

FIG. 1 is a perspective view of an inductor relating to one exemplified embodiment of the present invention;

FIG. 2 is a vertical cross-sectional view of an inductor relating to one exemplified embodiment of the present invention;

FIG. 3 are manufacturing process views of an inductor relating to one exemplified embodiment of the present invention;

FIG. 4 is a schematic view of a die used when manufacturing an inductor relating to one exemplified embodiment of the present invention;

FIG. 5 are a perspective view and a vertical cross-sectional view of a drum type core used for an inductor relating to one exemplified embodiment;

FIG. 6 is a perspective view of an inductor relating to one exemplified embodiment of the present invention;

FIG. 7 is a vertical cross-sectional view of an inductor relating to one exemplified embodiment of the present invention;

FIG. 8 are manufacturing process views of an inductor relating to one exemplified embodiment of the present invention;

FIG. 9 is a perspective view of an inductor relating to one exemplified embodiment of the present invention;

FIG. 10 is a vertical cross-sectional view of an inductor relating to one exemplified embodiment of the present invention; and

FIG. 11 are manufacturing process views of an inductor relating to one exemplified embodiment of the present invention.

### BEST MODE FOR CARRYING OUT THE INVENTION

Hereinafter, it will be explained with respect to one exemplified embodiment for practicing a coil component relating to the present invention with reference to the drawings, but the present invention is not limited by the exemplified embodiments hereinafter. Also, with respect to the manufacturing method of the coil component relating to the present invention, it will be explained together with the coil component.

### First Exemplified Embodiment

First, it will be explained with respect to a first exemplified embodiment of a coil component of the present invention.

FIG. 1 is a perspective view of an inductor 10 relating to one exemplified embodiment of the present invention.

As shown in FIG. 1, the inductor 10 is constituted by a core 1, a coil 2 wound on the core 1, a filling member 3 coating the coil 2 and a connection terminal 4.

The core 1 is a drum type core constituted by an upper flange 1b, a lower flange 1c and a winding core portion 1a which is provided so as to link the upper flange 1b and the lower flange 1c.

The core 1 is molded by a compound material which is constituted by mixing a soft magnetic metal material of sendust or the like as a magnetic material and a thermo-setting resin of an epoxy resin or the like as a resin material. In addition, instead of the thermo-setting resin, it is also allowed to use a compound material constituted by mixing a thermoplastic resin of poly phenylene sulfide (PPS) or the like. Here, the mixing ratio of the soft magnetic metal material and the resin is set with reference to the volume ratio thereof such that the soft magnetic metal material will be contained from 30 vol % or more to 70 vol % or less.

When the volume ratio of the soft magnetic metal material is less than 30%, it becomes impossible for the magnetic permeability to be maintained as a suitable value and on an occasion of 70% or more, it becomes impossible for the molding flowability to be maintained. In the mixture ratio mentioned above, the larger the resin compounding ratio is made, the more withstand voltage effect and anticorrosive effect can be obtained. It should be noted that by changing the grain size distribution state of the magnetic powders caused by adjusting the mixing ratio, it is possible to adjust molding flowability.

For the thermo-setting resin, it is also allowed to use a polyurethane resin and for the thermoplastic resin, it is also allowed to use a heat-resistant nylon. Generally, a thermoplastic resin is excellent in flowability compared with a thermo-setting resin, so that the core molding can be easily performed. Also, a resin having a functional group, such as epoxy, urethane, nylon and the like, is excellent in powder fillability compared with a resin without having a functional group, such as PPS, LCP and the like, so that it is possible to mold a core having an excellent magnetic characteristic.

The coil 2 is formed by a wire having an insulating film thereon. Also, at both the end portions of the wire, there are formed coil end portions 2a, which are not shown, for flowing an electric current supplied from an electronic apparatus in which the inductor 10 is mounted. The coil 2 is housed in the core by winding-around the wire on the winding core portion 1a of the core 1 while rotating the core 1.

The filling member 3 is constituted by a compound material which is obtained by mixing a soft magnetic metal material of sendust or the like as a magnetic material and a thermo-setting resin of an epoxy resin or the like as a resin material. This filling member is filled between the upper flange 1b and the lower flange 1c of the core 1 so as to cover the surface of the coil 2.

The terminal member 4 is formed by a metal plate processed in a flat plate shape. It should be noted that the metal terminal member 4 is attached on the lower flange 1c of the core 1 so as not to contact with the filling member 3. In this manner, by attaching the terminal member 4 so as not to contact with the filling member 3, it is possible to prevent a phenomenon that the electric current supplied from the electronic apparatus or the like mounted with the inductor 10 happens to leak from the terminal member 4 to the filling member 3. It should be noted that the terminal member 4 is attached also on a symmetrical position of the lower flange 1c and the coil end portion 2a is connected to the terminal member 4 on each side.

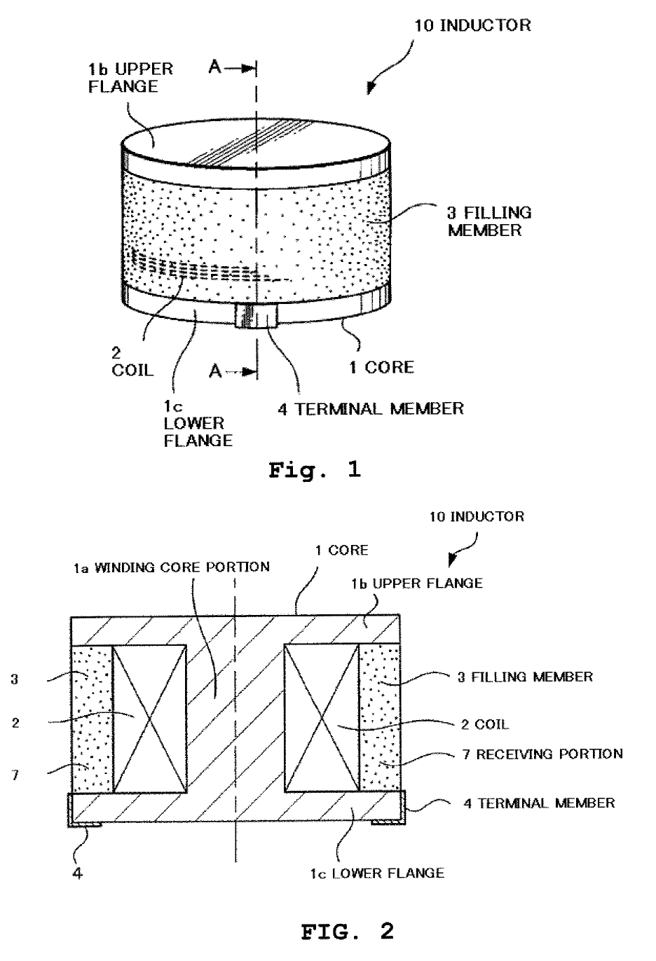

FIG. 2 is a cross-sectional view on an A-A line of the inductor 10 shown in FIG. 1.

As shown in FIG. 2, for the winding core portion 1a of the core 1, there is housed the coil 2 by being wound. The connection terminal 4 is bent in an L-shape and is attached from the bottom surface beyond the side surface of the lower flange 1c. Thus, the connection terminal 4 is connected to the electronic apparatus mounted with the inductor 10 and the electric current supplied from the electronic apparatus is supplied from the coil end portion 2a to the inductor 10 through the terminal member 4. Also, the pasty filling member 3 is filled in a receiving portion 7 formed by the end portion of the upper flange 1b, the end portion of the lower flange 1c and the surface of the coil 2 and coats the surface of the coil 2.

At that time, it is also allowed for the compound material to be adjusted such that line expansion coefficient of the compound material constituting the filling member 3 and line expansion coefficient of the compound material constituting the core 1 will become equal. Thus, the line expansion coefficients of the compound material of the filling member 3 and the compound material of the core 1 are made to be approached each other in which it is possible to approximate deformation ratio of the filling member 3 with respect to disturbance of heat or the like and deformation ratio of the core 1, and it is possible to prevent the flange portions 1b, 1c of the core 1 from being damaged based on a phenomenon that the filling member 3 filled in the receiving portion 7 is deformed.

According to the inductor 10 of this exemplified embodiment, depending on a fact that the receiving portion 7 for filling the filling material 3 for coating the coil 2 is provided, it is possible to easily coat the coil 2 which is housed in the coil component by filling the material 3 in this receiving portion 7.

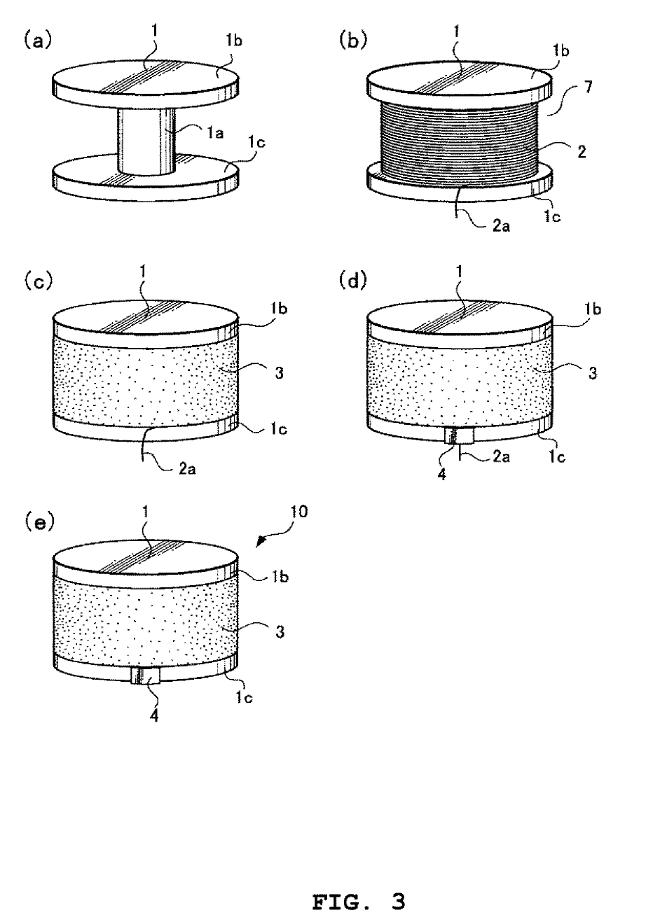

Next, by using FIG. 3, one example of a manufacturing process of the inductor 10 according to this exemplified embodiment will be explained hereinafter.

First, a core 1 shown in FIG. 3A is molded by injection molding. Specifically, it is molded by using a MIM (Metal Injection Molding) method.

Here, the MIM method means a complex technical method produced by merging a plastic injection molding method and a metal powder metallurgical method which have been used from the past. By injection molding which uses a die and depends on the MIM method, it is possible to easily manufacture a minute & precise component and a component of a complex shape or of a three-dimensional shape, to which the machining process is difficult to be applied.

In this exemplified embodiment, by using the MIM method, it is possible to easily manufacture the core 1 having a flanged shape in which the filling member can be filled easily. Also, by manufacturing the core 1 depending on the injection molding using the composite material of the magnetic material and the resin, it is possible to heighten the strength of the core 1. Further, it is possible to eliminate the cutting process when molding the core and it is possible to improve the yield of the material.

In this exemplified embodiment, metal powder and binder are mixed and kneaded uniformly (mixing and kneading process) and thereafter, by using a mixing and kneading machine, it is made to be a pellet having excellent moldability (pelletizing process) and next, by calculating contraction of the material, which occurs caused by temperature and pressure applied to the pellet, the die is designed (injection molding process).

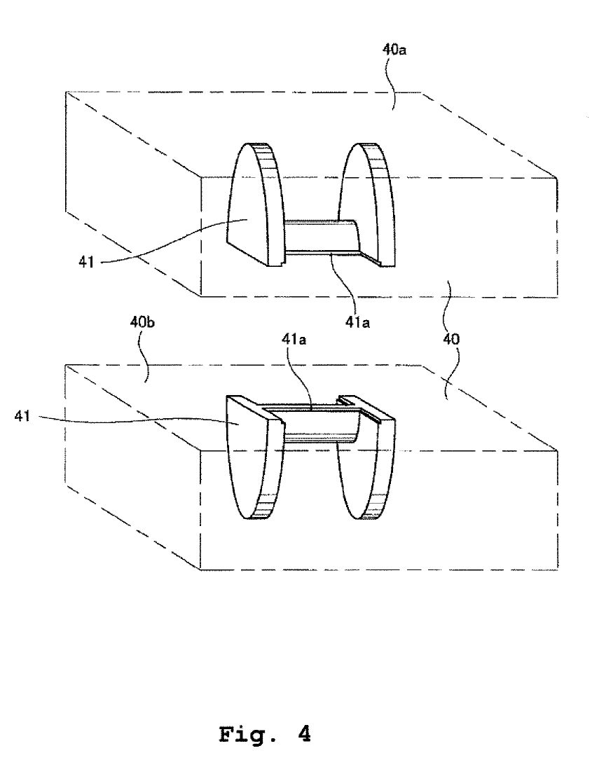

FIG. 4 is an explanatory view of a die used in the injection molding process in this exemplified embodiment.

A die 40 is constituted by a combination of an upper die 40a and a lower die 40b. A model 41 of a drum core which is to be manufactured from the dies 40a, 40b, is formed in a symmetrical shape including two pieces. The upper die 40a and the lower die 40b are mated and from a predetermined injection entrance of the filling material, for example, a pasty compound material constituted by mixing a soft magnetic metal material of sendust or the like as a magnetic material and a thermo-setting resin of an epoxy resin or the like as a resin material is injected and a drum type core is manufactured. Here, if necessary, it is also allowed to employ sintering after applying binder removal.

Next, as shown in FIG. 3B, the coil 2 is wound on the winding core portion 1a of the core 1 formed by injection molding so as to obtain a desired number of turns. At that time, the receiving portion 7 for filling the filling member is formed by the upper flange 1b and the lower flange 1c of the core, and the wound coil 2. Also, the coil end portion 2a of the coil is pulled out so as to be contacted with the lower flange 1c.

Next, as shown in FIG. 3C, a pasty compound material constituted by mixing a soft magnetic metal material of sendust or the like as a magnetic material and a thermo-setting resin of an epoxy resin or the like as a resin material is filled in the receiving portion 7 formed among the coil 2, the upper flange 1b and the lower flange 1c, and the surface of the coil 2 is coated.

Next, as shown in FIG. 3D, the metal terminal member 4 is bonded at the lower flange 1c in the vicinity of a place from which the coil end portion 2a is pulled out. It should be noted with respect to the core formed by using the MIM method as this exemplified embodiment that the core will melt caused by high temperature, so that it is not possible to form an electrode by baking when the MIM method without a sintering process is used.

Next, as shown in FIG. 3E, the coil end portion 2a and the connection terminal 4 are connected by soldering or welding.

According to a manufacturing method of the inductor 10 of this exemplified embodiment, by filling the filling material in the receiving portion 7 formed in the core 1, it is possible to easily coat the surface of the coil 2 housed in the coil component.

It should be noted that in the molding by using such a die as mentioned above, a line-shaped protrusion (parting line) may be formed on the molded product because the resin which is filled enter into a gap formed between the upper die 40a and the lower die 40b which are mated. For this reason, as shown in FIG. 4, it is also allowed for the die 40 to be formed with concave portions 41a along the winding core direction of the models 41 which are formed in the die 40.

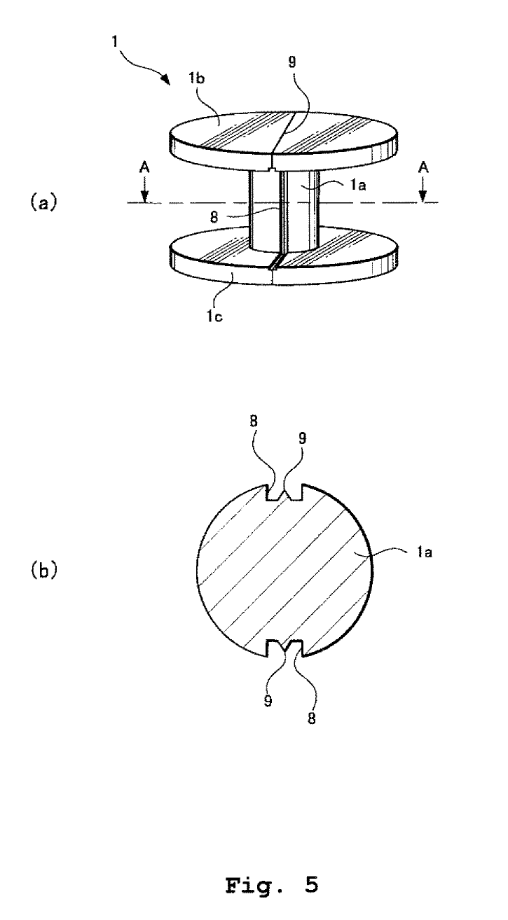

FIG. 5A is a perspective view of a drum type core 1 manufactured by the die mentioned above.

As shown in FIG. 5A, caused by the concave portion 41a formed in the model 41 of the die 40, the core 1 is formed with one line of groove 8 which passes the winding core portion 1a from the upper surface end portion of the lower flange 1c and which passes to the lower surface end portion of the upper flange 1b. It should be noted that this groove 8 is formed in a similar shape also at a symmetrical position of the core.

FIG. 5B is a cross-sectional view on an A-A line of the core 1 shown in FIG. 5A.

As shown in FIG. 5B, at the circumferential edge of the winding core portion 1a, there are formed the grooves 8 at positions which become symmetrical. Also, as shown in the drawing, the parting line 9 mentioned above is formed in the inside of the groove 8. In this manner, by using the die 40 in which the parting line 9 is formed in the inside of the groove 8, it is possible, in case of winding the coil 2 around the winding core portion 1a, to prevent the wire from being damaged caused by the parting line 9 formed on the core.

### Second Exemplified Embodiment

Next, it will be explained with respect to a second exemplified embodiment of a coil component of the present invention.

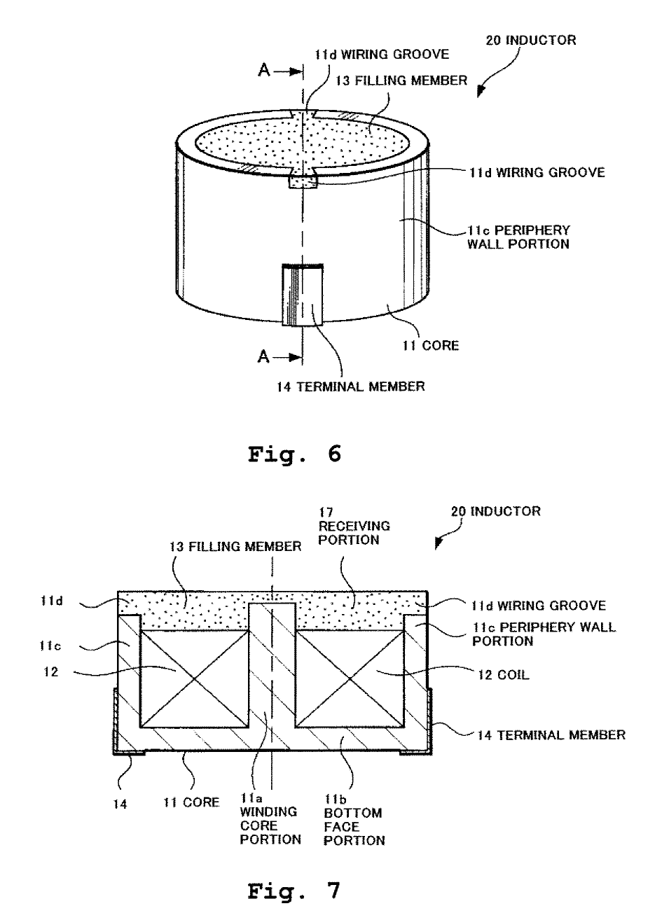

FIG. 6 is a perspective view of an inductor 20 relating to one exemplified embodiment of the present invention.

As shown in FIG. 6, the inductor 20 relating to this exemplified embodiment is constituted by a core 11, a coil 12 housed in the core 11, a filling member 13 coating the coil 12 and a connection terminal 14.

The core 11 is a pot type core constituted by a circular bottom face portion 11b, a periphery wall portion 11c linked along the periphery of the bottom face portion 11b and an axial core portion 11a provided at the center of the bottom face portion 11b. Also, at an upper end portion of the periphery wall portion 11c, there are formed wiring grooves 11d for pulling out coil end portions 12a of the coil 12 housed in the inside of the core 11 to the outside. It should be noted that the axial core portion 11a, the bottom face portion 11b and the coil 12 are not shown in the drawing.

The core 11 is molded by a compound material which is constituted by mixing a soft magnetic metal material of sendust or the like as a magnetic material and a thermo-setting resin of an epoxy resin or the like as a resin material. In addition, instead of the thermo-setting resin, it is also allowed to use a compound material constituted by mixing a thermoplastic resin of poly phenylene sulfide (PPS) or the like. Here, the mixing ratio of the soft magnetic metal material and the resin is set with reference to the volume ratio thereof such that the soft magnetic metal material will be contained from 30 vol % or more to 70 vol % or less.

When the volume ratio of the soft magnetic metal material is less than 30%, it becomes impossible for the magnetic permeability to be maintained as a suitable value and on an occasion of 70% or more, it becomes impossible for the molding flowability to be maintained. In the mixture ratio mentioned above, the larger the resin compounding ratio is made, the more withstand voltage effect and anticorrosive effect can be obtained. It should be noted that by changing the grain size distribution state of the magnetic powders caused by adjusting the mixing ratio, it is possible to adjust molding flowability.

For the thermo-setting resin, it is also allowed to use a polyurethane resin and for the thermoplastic resin, it is also allowed to use a heat-resistant nylon. Generally, a thermoplastic resin is excellent in flowability compared with a thermo-setting resin, so that the core molding can be easily performed. Also, a resin having a functional group, such as epoxy, urethane, nylon and the like, is excellent in powder fillability compared with a resin without having a functional group, such as PPS, LCP and the like, so that it is possible to mold a core having an excellent magnetic characteristic.

The coil 12 is an air core coil having an air core coil portion 12b formed by a wire having an insulating film. Also, at both the end portions of the wire, there are formed coil end portions 12a for flowing an electric current supplied from an electronic apparatus in which the inductor 20 is mounted. It should be noted that the coil end portions 12a and the air core portion 12b are not shown in the drawing.

The filling member 13 is constituted by a compound material which is obtained by mixing a soft magnetic metal material of sendust or the like as a magnetic material and a thermo-setting resin of an epoxy resin or the like as a resin material. This filling member is filled between the periphery wall portion 11c of the core 11 and the upper surface of the coil 12 so as to cover the upper surface of the coil 12.

The terminal member 14 is formed by a metal plate processed in a flat plate shape. The terminal member 14 is attached to the periphery wall portion 11c below the wiring groove 11d. In addition, the terminal member 14 is attached also on a symmetrical position of the periphery wall portion 11c and the coil end portion 12a is connected to the terminal member 14 on each side.

FIG. 7 is a cross-sectional view on an A-A line of the inductor 20 shown in FIG. 6.

As shown in FIG. 7, for the axial core portion 11a of the core 11, there is housed the coil 12 by inserting the air core portion 12b of the air core coil 12. The connection terminal 14 is bent in an L-shape and is attached from the bottom face portion 11b beyond the periphery wall portion 11c. Thus, the connection terminal 14 is connected to the electronic apparatus mounted with the inductor 20 and the electric current supplied from the electronic apparatus is supplied from the coil end portion 12a to the inductor 20 through the terminal member 14. Also, the pasty filling member 13 is filled in a receiving portion 17 formed by the inner surface of the periphery wall portion 11c, the protrusion portion of the axial core portion 11a and the upper surface of the coil 12 and coats the surface of the coil 12.

At that time, it is also allowed for the compound material to be adjusted such that line expansion coefficient of the compound material constituting the filling member 13 and line expansion coefficient of the compound material constituting the core 11 will become equal. Thus, the line expansion coefficients of the compound material of the filling member 13 and the compound material of the core 11 are made to be approached each other in which it is possible to approximate deformation ratio of the filling member 13 with respect to disturbance of heat or the like and deformation ratio of the core 11, and it is possible to prevent the axial core portion 11a and the periphery wall portion 11c of the core 11 from being damaged based on a phenomenon that the filling member 13 filled in the receiving portion 17 is deformed.

According to the inductor 20 of this exemplified embodiment, depending on a fact that the receiving portion 17 for filling the filling material 13 for coating the coil 12 is provided, it is possible to easily coat the coil 12 which is housed in the coil component by filling the material 13 in this receiving portion 17.

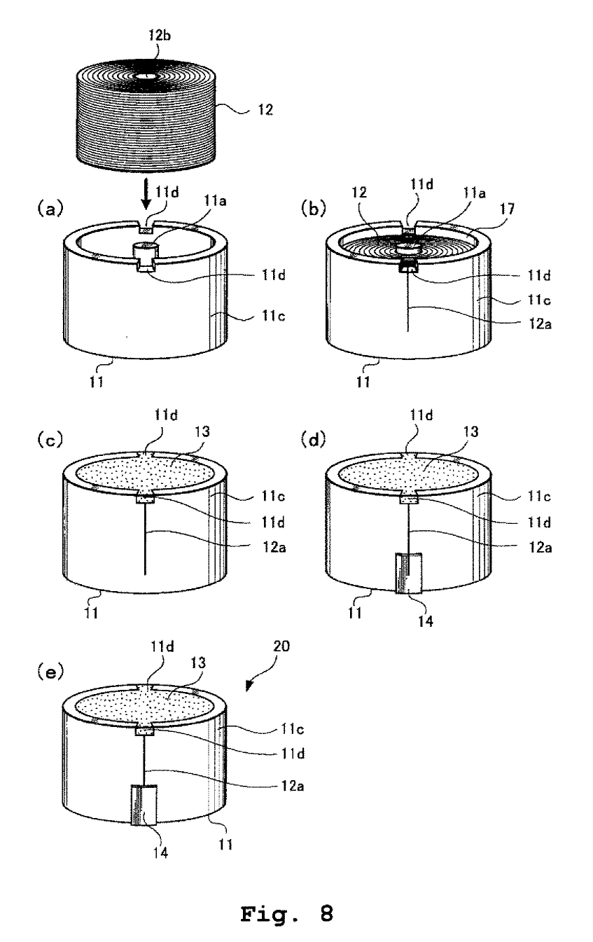

Next, by using FIG. 8, one example of a manufacturing process of the inductor 20 according to this exemplified embodiment will be explained hereinafter.

First, a pot type core 11 shown in FIG. 8A is molded by injection molding. Specifically, it is molded by using a MIM (Metal Injection Molding) method.

In this exemplified embodiment, by using the MIM method, it is possible to easily manufacture the core 11 having the periphery wall portion 11c in which the filling member can be filled easily. Also, by manufacturing the core 11 depending on the injection molding using the composite material of the magnetic material and the resin, it is possible to heighten the strength of the core 11. Further, it is possible to eliminate the cutting process when molding the core and it is possible to improve the yield of the material.

In this exemplified embodiment, metal powder and binder are mixed and kneaded uniformly (mixing and kneading process) and thereafter, by using a mixing and kneading machine, it is made to be a pellet having excellent moldability (pelletizing process) and next, by calculating contraction of the material, which occurs caused by temperature and pressure applied to the pellet, the die is designed (injection molding process).

Next, as shown in FIG. 8B, the air core portion 12b of the air core coil 12 is inserted to the axial core portion 11a of the core 11 molded by injection molding. At that time, the receiving portion 17 for filling the filling member is formed by the periphery wall portion 11c of the core, the axial core portion 11a and the upper surface of the coil 12. Also, the coil end portion 12a of the coil is pulled out to the outside through the wiring groove 11d.

Next, as shown in FIG. 8C, the pasty compound material constituted by mixing a soft magnetic metal material of sendust or the like as a magnetic material and a thermo-setting resin of an epoxy resin or the like as a resin material is filled in the receiving portion 17 formed among the periphery wall portion 11c, the axial core portion 11a and the upper surface of the coil 12, and the upper surface of the coil 12 is coated. At that time, it is also allowed to fill the filling material also with respect to the wiring groove 11d formed at the periphery wall portion 11c.

Next, as shown in FIG. 8D, the metal terminal member 14 is bonded at the periphery wall portion 11c in the vicinity of a place from which the coil end portion 12a is pulled out. It should be noted with respect to the core formed by using the MIM method as this exemplified embodiment that the core will melt caused by high temperature, so that it is not possible to form an electrode by baking when the MIM method without a sintering process is used.

Next, as shown in FIG. 8E, the coil end portion 12a and the connection terminal 14 are connected by soldering or welding. At that time, in order to prevent disconnection of the wire of the coil which is pulled out to the outside of the core, it is also allowed for the wire pulled out from the wiring groove 11d to be applied with a silicon resin, an epoxy resin or the like which has electrical insulation property.

According to a manufacturing method of the inductor 20 of this exemplified embodiment, by filling the filling material in the receiving portion 17 formed in the core 11, it is possible to easily coat the upper surface of the coil 12 housed in the coil component.

### Third Exemplified Embodiment

Next, it will be explained with respect to a third exemplified embodiment of a coil component of the present invention.

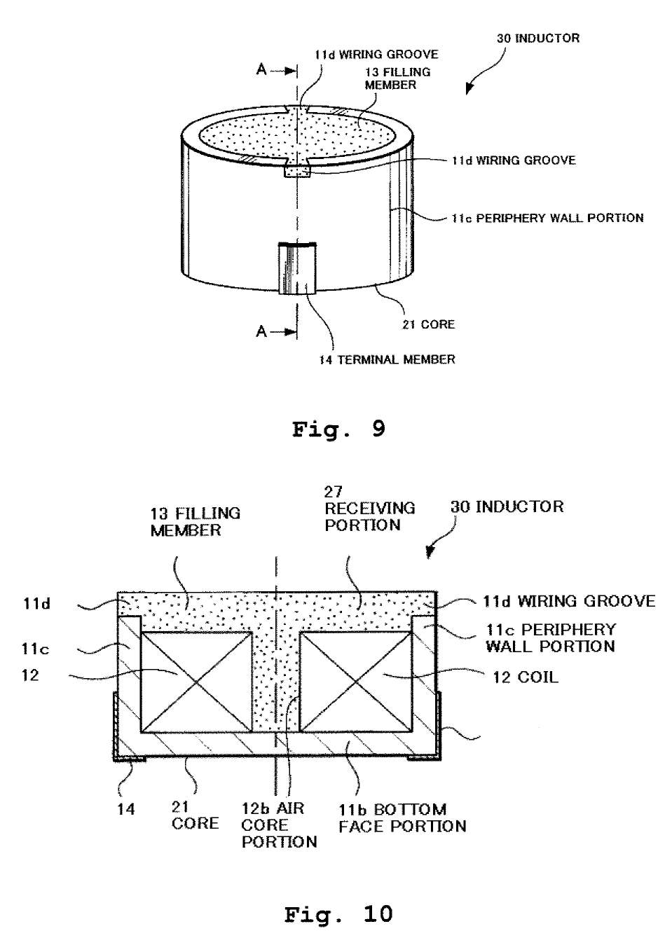

FIG. 9 is a perspective view of an inductor 30 relating to one exemplified embodiment of the present invention.

In FIG. 9, the same reference numerals are applied to portions corresponding to those in FIG. 6 and the explanation thereof will be omitted.

As shown in FIG. 9, the inductor 30 relating to this exemplified embodiment is constituted by a core 21 and a coil 12 which is housed in the core 21 and which is not shown in the drawing, a filling member 13 coating the coil 12 and a connection terminal 14.

The core 21 is a pot type core constituted by a circular bottom face portion 11b and a periphery wall portion 11c linked along the periphery of the bottom face portion 11b. Also, at the upper end portion of the periphery wall portion 11c, there are formed wiring grooves 11d for pulling out end portions 12a of the coil 12 housed in the inside of the core 21.

The core 21 is molded by a compound material which is constituted by mixing a soft magnetic metal material of sendust or the like as a magnetic material and a thermo-setting resin of an epoxy resin or the like as a resin material. In addition, instead of the thermo-setting resin, it is also allowed to use a compound material constituted by mixing a thermoplastic resin of poly phenylene sulfide (PPS) or the like. Here, the mixing ratio of the soft magnetic metal material and the resin is set with reference to the volume ratio thereof such that the soft magnetic metal material will be contained from 30 vol % or more to 70 vol % or less.

When the volume ratio of the soft magnetic metal material is less than 30%, it becomes impossible for the magnetic permeability to be maintained as a suitable value and on an occasion of 70% or more, it becomes impossible for the molding flowability to be maintained. In the mixture ratio mentioned above, the larger the resin compounding ratio is made, the more withstand voltage effect and anticorrosive effect can be obtained. It should be noted that by changing the grain size distribution state of the magnetic powders caused by adjusting the mixing ratio, it is possible to adjust molding flowability.

For the thermo-setting resin, it is also allowed to use a polyurethane resin and for the thermoplastic resin, it is also allowed to use a heat-resistant nylon. Generally, a thermoplastic resin is excellent in flowability compared with a thermo-setting resin, so that the core molding can be easily performed. Also, a resin having a functional group, such as epoxy, urethane, nylon and the like, is excellent in powder fillability compared with a resin without having a functional group, such as PPS, LCP and the like, so that it is possible to mold a core having an excellent magnetic characteristic.

The coil 12, the filling member 13 and the terminal member 14 are similar to those explained in the second exemplified embodiment, so that the explanation thereof will be omitted.

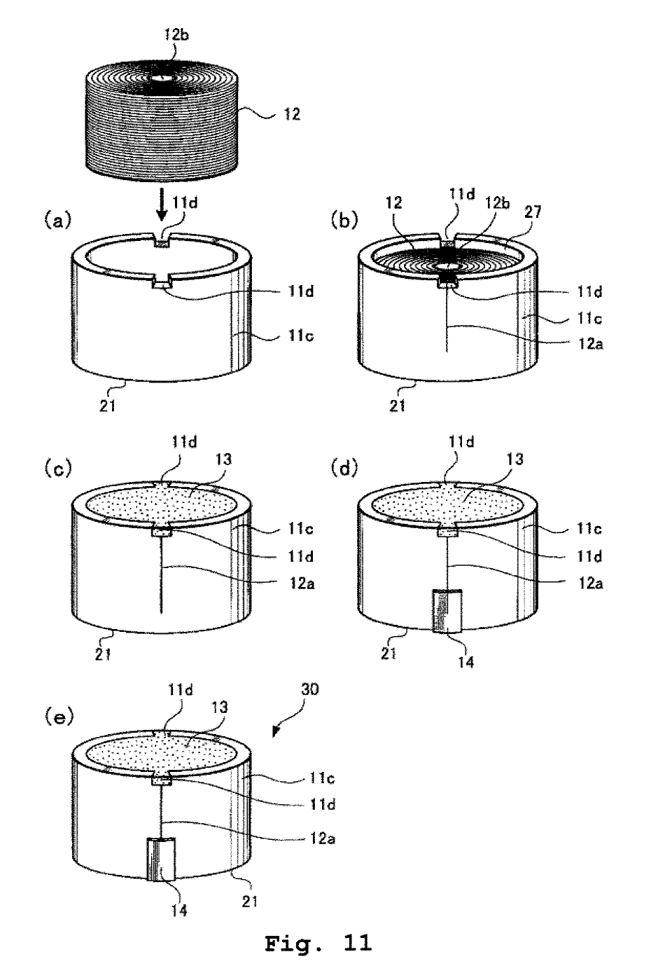

FIG. 10 is a cross-sectional view on an A-A line of the inductor 30 shown in FIG. 9.

As shown in FIG. 10, in the inside of the core 21, there is housed the coil 12 by placing the air core coil 12 on the bottom face portion 11b. The connection terminal 14 is bent in an L-shape and is attached from the bottom face portion 11b beyond the periphery wall portion 11c. Thus, the connection terminal 14 is connected to the electronic apparatus mounted with the inductor 30 and the electric current supplied from the electronic apparatus is supplied from the coil end portion 12a to the inductor 30 through the terminal member 14. Also, the filling member 13 is filled in a receiving portion 27 formed by the inner surface of the periphery wall portion 11c, the air core portion 12b of the air core coil and the upper surface of the coil 12 and coats the surface of the coil 12.

At that time, it is also allowed for the compound material to be adjusted such that line expansion coefficient of the compound material constituting the filling member 13 and line expansion coefficient of the compound material constituting the core 21 will become equal. Thus, the line expansion coefficients of the compound material of the filling member 13 and the compound material of the core 21 are made to be approached each other in which it is possible to approximate deformation ratio of the filling member 13 with respect to disturbance of heat or the like and deformation ratio of the core 21, and it is possible to prevent the periphery wall portion 11c of the core 21 from being damaged based on a phenomenon that the filling member 13 filled in the receiving portion 27 is deformed.

According to the inductor 30 of this exemplified embodiment, depending on a fact that the receiving portion 27 for filling the filling material 13 for coating the coil 12 is provided, it is possible to easily coat the coil 12 which is housed in the coil component by filling the material 13 in this receiving portion 27.

Next, by using FIG. 11, one example of a manufacturing process of the inductor 30 according to this exemplified embodiment will be explained hereinafter.

First, a pot type core 21 shown in FIG. 11A is formed by injection molding. To be molded by using a MIM (Metal Injection Molding) method is similar to the second exemplified embodiment, so that the explanation thereof will be omitted.

Next, as shown in FIG. 11B, the air core coil 12 is housed in the core 11 formed by injection molding. At that time, the receiving portion 27 for filling the filling member is formed by the periphery wall portion 11c of the core, the air core portion 12b of the coil 12 and the upper surface of the coil 12. Also, the coil end portion 12a of the coil is pulled out to the outside through the wiring groove 11d.

Next, as shown in FIG. 11C, the pasty compound material constituted by mixing a soft magnetic metal material of sendust or the like as a magnetic material and a thermo-setting resin of an epoxy resin or the like as a resin material is filled in the receiving portion 27 formed among the periphery wall portion 11c, the air core portion 12b of the coil and the upper surface of the coil 12, and the surface of the coil 12 is coated. At that time, it is also allowed to fill the compound material also with respect to the wiring groove 11d formed at the periphery wall portion 11c.

Next, as shown in FIG. 11D, the metal connection terminal 14 is bonded at the periphery wall portion 11c in the vicinity of a place from which the coil end portion 12a is pulled out. It should be noted with respect to the core formed by using the MIM method as this exemplified embodiment that the core will melt caused by high temperature, so that it is not possible to form an electrode by baking when the MIM method without a sintering process is used.

Next, as shown in FIG. 11E, the coil end portion 12a and the connection terminal 14 are connected by the soldering or the welding. At that time, in order to prevent disconnection of the wire of the coil which is pulled out, it is also allowed for the wire pulled out from the wiring groove 11d to be applied with a silicon resin, an epoxy resin or the like which has electrical insulation property.

According to a manufacturing method of the inductor 30 of this exemplified embodiment, by filling the filling material in the receiving portion 27 formed in the core 21, it is possible to easily coat the upper surface and the air core portion 12b portion of the coil 12 housed in the coil component.

It should be noted that the coil component and the manufacturing method of the present invention are not limited by the respective exemplified embodiments mentioned above, and it is needless to say that various modifications and variations are available with respect to other materials, configurations and the like without departing from the constitution of the present invention.

### DESCRIPTION OF REFERENCE NUMERALS

1, 11, 21: core; 1a: winding core portion; 1b, 1c: flange; 2, 12: coil; 2a, 12a: coil end portion; 3, 13: filling member; 4, 14: connection terminal; 7, 17, 27: receiving portion; 8: groove; 9: parting line; 10, 20, 30: inductor; 11a: axial core portion; 11b: bottom face portion; 11c: periphery wall portion; 11d: wiring groove; 12b: air core portion

1. In a coil component characterized by comprising:
a coil;
a compound magnetic core constituted by a soft magnetic metal material and a resin material; and
a compound magnetic resin constituted by a soft magnetic metal material and a resin material, in which
it is constituted such that magnetic flux excited by said coil serially goes through said compound magnetic core and said compound magnetic resin, wherein
said compound magnetic core is constituted by injection molding so as to include a receiving portion, and
said coil is arranged in said receiving portion and said compound magnetic resin is filled therein.

2. The coil component according to claim 1 characterized in that
said compound magnetic core is constituted by a soft magnetic metal material and a thermo-setting resin material or a thermoplastic resin material.

3. A manufacturing method characterized by comprising:
a process of molding a core by injection-molding a compound material constituted by a soft magnetic metal material and resin material;
a process of housing a coil in said molded core; and
a process of coating said coil with a compound material constituted by a soft magnetic metal material and a resin material after housing said coil in said core.
